(19) United States
(12) Patent Application Publication
(10) Pub. No.: US 2008/0145532 A1
(43) Pub. Date: Jun. 19, 2008

(54) Method of making tactile features on cartons

(76) Inventor: Duane Lyle McDonald, Neenah, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/639,943

(22) Filed: Dec. 15, 2006

(51) Int. Cl. B05D 5/02

(52) U.S. Cl. 427/244

(57) ABSTRACT

A textured or soft-feel exterior surface of a carton can be created by applying a coating material to the carton prior to filling the carton with a consumer product such as facial tissue. In one embodiment, the carton is then filled with the consumer product after which the coating material is activated by heating to form the textured surface. By activating the coating material after filling the carton, the carton is able to be processed on existing equipment, and the soft-feel material is less likely to be damaged by the machinery during the filling operation.

### BACKGROUND

Cartons are used in a wide variety of industries to package consumer products, including, but not limited to, food products; personal care products; paper products such as facial tissue, bath tissue, paper towels or paper napkins; absorbent article products such as sanitary napkins, incontinence pads, or diapers; fabric softeners, soaps, and skin care products. Cartons may be used both as the primary packaging to hold the product and as the secondary packaging to hold a plurality of individual cartons during transport to a retailer. Facial tissue paper is frequently packaged in individual cartons that can function as a package to contain the facial tissue and as a dispenser to remove individual tissue paper sheets from the carton when needed.

Generally, the exterior surfaces of the carton are printed with graphics to make the carton visually appealing and with text to convey necessary consumer information such as ingredients, trademarks, patent protection, and the manufacturer. The printed graphics often have a clear varnish over the printing inks to protect the graphics from damage as the carton is manipulated by the automatic machinery to fill it with tissue. During the facial tissue filling process, a carton sleeve is often removed from a feed magazine holding a stack of flat carton sleeves, the carton sleeve is opened into a tubular shape, the closing flaps on one end are sealed shut, a facial tissue stack is inserted into the other end, and the closing flaps on the opposite end are sealed shut. The individual filled carton can be collated and assembled into a larger rectangular array with numerous other cartons for insertion into a larger shipping box by a case packer. During the extensive manipulation of the carton through the line, the outer surface of the carton is subjected to numerous components that can scratch or damage the graphics on the carton. Additionally, the surface characteristics of the carton play an important role in the ability of the machinery to remove a carton sleeve at high speeds from the feed magazine without jamming, misfeeding, or inadvertently pulling out multiple carton sleeves from the feed magazine.

Increasingly, consumers of facial tissue products are drawn to cartons having more elaborate graphical treatments, such as metallic foils, lenticular or Fresnel lenses, and holographic elements to name a few of the possibilities. Consumers like to coordinate the facial tissue carton design with their home decor and they will change the carton's graphics to reflect the seasons, holidays, or decorating trends. One aspect of the carton's graphical treatment that has not received much attention is the use of three-dimensional or tactile surface treatments to provide a softer feel to the carton's exterior surface than the hard, smooth, clear varnish of existing cartons. A soft-feel carton can be used to reinforce or promote the softness of the facial tissue inside.

The exterior varnish of existing cartons is utilized to protect the graphics and to improve the carton's filling efficiency by providing a surface that reduces jamming or misfeeding during the filling operation. Soft, sticky, three-dimensional, or tactile features on the carton's exterior surfaces are problematic with the existing carton filling operation. Therefore, what is needed is a method of making tactile features on a carton's exterior surface that is compatible with the existing machinery used to fill the carton with facial tissue.

### SUMMARY

The inventor has discovered that the above needs can be met by utilizing a coating material that blooms or expands to provide three-dimensionality when activated by being subjected to heat. In one embodiment, the coating material is applied along with the printing inks and other graphical elements to the carton's exterior surface. The carton sleeve with the coating material is then placed into the feed magazine of an automatic carton filling line. The carton is filled with the desired product and sealed shut. Thereafter, the carton is subjected to a heating operation to raise the temperature of the exterior surface activating the coating material to provide a soft-feel or three-dimensional surface texture. Since the carton's soft-feel exterior is provided after filling the carton with tissue, the textured surface does not interfere with the handling of the carton during the filling operation. As a result, jamming or misfeeding of the carton during filling with tissue is not a problem since the carton's exterior surface is relatively smooth until heat activated. Furthermore, since the soft-feel surface is created after the carton has been filled, the soft-feel exterior surface is less likely to be damaged during the filling operation.

Hence, in one aspect, the invention resides in a method of making a textured carton surface, including the steps of applying a coating material, to the exterior surface of a carton blank or a carton sleeve; placing the carton sleeve into a feed magazine of a carton filling line; removing the carton sleeve from the feed magazine; and thereafter heating the exterior surface activating the coating material forming the textured carton surface.

### BRIEF DESCRIPTION OF THE DRAWINGS

The above aspects and other features, aspects, and advantages of the present invention will become better understood with regard to the following description, appended claims, and accompanying drawings in which:

FIG. 1 is a schematic of a carton filling process.

FIG. 2 is a partial plan view of a carton surface having a tactile feature.

FIG. 3A is a cross section of FIG. 2 taken at 3-3 prior to the carton's exterior surface being treated with heat.

FIG. 3B is a cross section of FIG. 2 taken at 3-3 after the carton's exterior surface has been treated with heat.

Repeated use of reference characters in the specification and drawings is intended to represent the same or analogous features or elements of the invention in different embodiments.

### DEFINITIONS

As used herein, forms of the words “comprise”, “have”, and “include” are legally equivalent and open-ended. Therefore, additional non-recited elements, functions, steps or limitations may be present in addition to the recited elements, functions, steps, or limitations.

### DETAILED DESCRIPTION

It is to be understood by one of ordinary skill in the art that the present discussion is a description of exemplary embodiments only and is not intended as limiting the broader aspects of the present invention, which broader aspects are embodied in the exemplary construction.

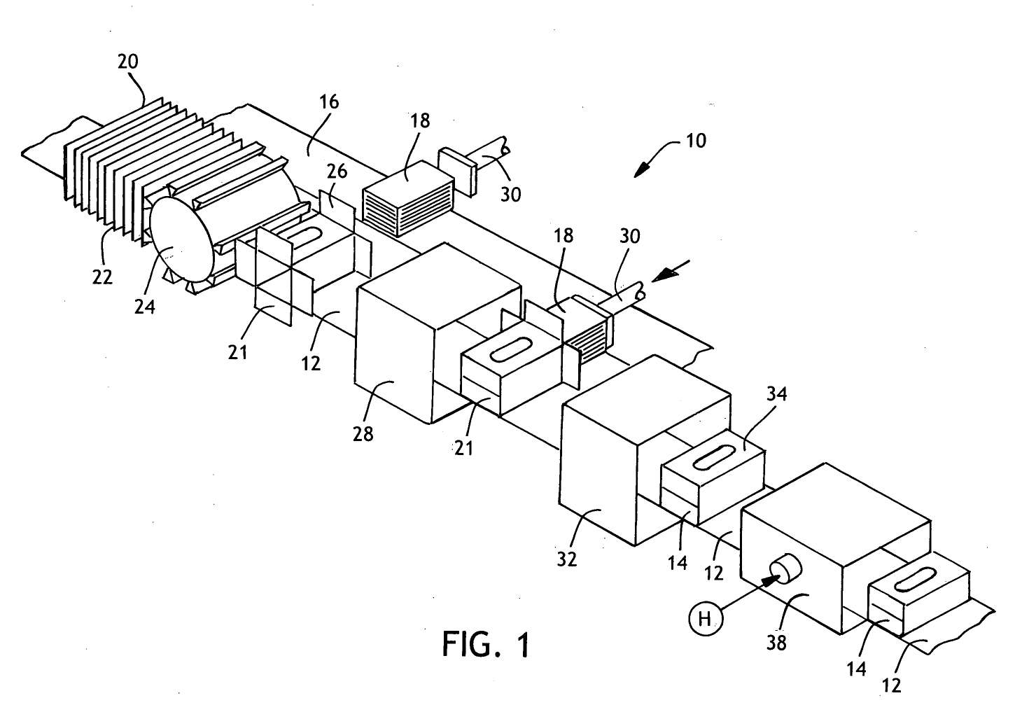

Referring to FIG. 1, a carton filling line 10 to package a consumer product is illustrated. The carton filling line includes a carton conveyer 12 conveying a plurality of cartons 14, and a tissue conveyor 16 conveying a plurality of facial tissue stacks 18. The facial tissue stacks are folded, assembled, and cut to length prior to being placed on the tissue conveyor 16 by additional equipment that is not illustrated. The carton filling line 10 has a plurality of carton sleeves 20 disposed in a feed magazine 22. An orbital erecting module 24 takes a carton sleeve 20 from the feed magazine 22 and opens the carton sleeve into a tubular shape 21 with a plurality of opened sealing flaps 26 on each end as illustrated. As used herein, “tubular shape” means that the center of the object is hollow and that the object has at least one open end to enable the insertion of another product or goods into the tubular shape. The tubular shape 21 can have any desired cross-sectional shape, such as square, rectangular, round, or oval.

A first sealing module 28 closes and adhesively glues the four sealing flaps 26 on one end of the tubular shape 21 into a closed position as the tubular shape is advanced by the carton conveyor 12. A pusher arm 30 then advances the tissue stack 18 into the opposing open end of the tubular shape 21. The tissue conveyor 16 and the carton conveyer 12 are indexed relative to each other to properly align the tissue stack 18 with the open end of the tubular shape 21. To assist with indexing, the tissue stack 18 may be disposed in a plurality of open ended buckets attached to the tissue conveyor 16. The carton sleeves 20 may be erected and placed between a plurality of indexing lugs attached to the carton conveyor 12. After placing the tissue stack 18 into the tubular shape 21, a second sealing module 32 closes and adhesively glues the four sealing flaps on the opposite end into a closed position, completing the assembly of the carton sleeve 20 into a carton 14.

Examples of carton filling lines are disclosed in U.S. Pat. No. 6,202,392 entitled Flexible Tissue Handling Apparatus issued to Greenwall et al. on Mar. 20, 2001, and in U.S. Pat. No. 7,073,310 entitled Flexible Carton Loading Apparatus issued to Long et al. on Jul. 11, 2006. Construction details of typical facial tissue cartons and the carton blanks that can be formed into the carton sleeves 20 and filled with facial tissue stacks 18 by the carton filling line 10 are disclosed in U.S. Pat. No. 3,940,054 entitled Tissue Carton, in U.S. Pat. No. 4,623,074 entitled Dual Dispensing Mode Carton and Concomitant Package, and in U.S. Pat. No. 6,910,600 entitled In-Line Windowed Facial Tissue Carton. Carton material useful to make the cartons includes paper based material such as paperboard, cardboard, clay coated newsback and solid bleached sulfite. Carton, as used herein, is understood as a container having any suitable shape for packaging products, goods, or materials. The carton need not be a parallelepiped shape as illustrated.

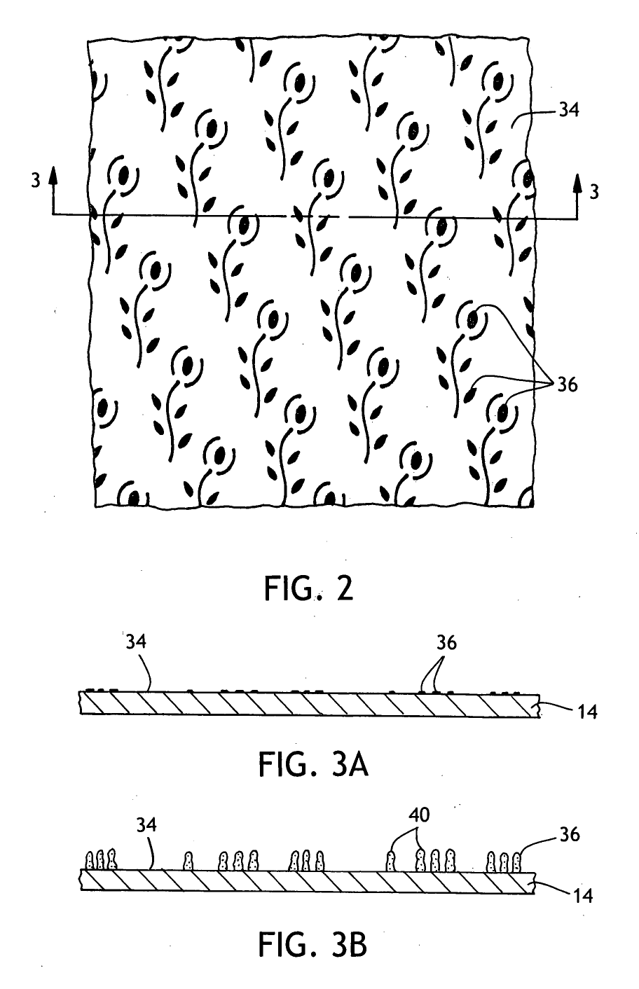

Referring now to FIGS. 2 and 3A, at least a portion of the exterior surface 34 of the carton 14 is provided with a coating material 36 that provides a soft, suede, elastic, textured, or velvety feel to the carton 14 after being activated. The coating material 36 may be applied onto the exterior surface 34 in various designs and graphical patterns as desired, such as the design illustrated in FIG. 2. The coating material can be applied using conventional techniques such as gravure coating, offset printing, screen printing, flexography, and the like similar to printing inks applied to the carton's exterior surface 34. Typically, the coating, material 36 will be applied to the surfaces of a carton blank, which is the unfolded flat carton shape, prior to folding and assembling the carton blank into the carton sleeve 20 by joining two opposing sides of the carton blank. The coating material 36 is initially relatively flat and smooth when initially printed onto the exterior surface 34 of the carton 14 and dried as shown in FIG. 3A prior to being activated. At this stage, the un-activated coating material 36 has a smoothness and texture similar to conventional printing inks.

The coating material 36 may have a thickness of between about 0.001 inch to about 0.100 inch prior to heat activation. For increased thickness, two, three, or more applications of the coating material 36 may be applied successively. The coating material 36 does not interfere with removing the carton sleeve 20 from the feed magazine 22 since the surface friction, texture, and characteristics of the carton's exterior surface 34 can be similar to the printed inks and clear varnish currently used. Similarly, the coating material 36 also does not interfere with erecting, filling, or sealing the carton 14 as it moves through the carton filling line 10 since the friction characteristics can be similar to that of printed inks and clear varnish.

To efficiently remove the carton sleeves 20 from the feed magazine 22 without sticking or bunching, it is desirable for the coefficient of friction of the outer surfaces 34 of the cartons 14 in contact with each other to be low. As the speed of the carton filling line 10 is increased, the surface characteristics of the carton sleeve 20 and/or the carton 14 can have a significant affect on the ability of the line to handle and fill the cartons efficiently. In particular, the inventor has determined that for improved efficiency of the carton filling line 10, the static coefficient of friction of an exterior surface 34 of a carton sleeve 20 in contact with an adjacent outer surface 34 of an adjacent carton sleeve 20 should be between about 0.05 to about 0.35, or between about 0.1 to about 0.30, or between about 0.1 to about 0.25.

Too low of a static coefficient of friction can make it difficult to grip and handle the carton 14 by the carton filling line 10 or by existing conveyor systems. Too high of a static coefficient of friction can make it difficult to remove a carton sleeve 20 from the feed magazine 22 or to assemble multiple cartons into an array for inserting into a shipping box.

Additionally, the carton filling line 10 is often optimized for a narrow range of the coefficient of friction of the exterior surface 34. Thus, significant changes in the coefficient of friction between cartons having a heat activated coating material 36 and cartons having only printing inks and varnish can be especially problematic when changing production to meet consumer demand for different types of cartons. To modify the static coefficient of friction, an additional coating can be applied over the heat activated coating material 36 if necessary to obtain the desired slip characteristics of the exterior surface 34. When the carton is heated, the heat activated coating material 36 can still expand and fracture the lighter top coating that was applied to modify the surface's coefficient of friction.

The static coefficient of friction can be tested on a Testing Machines Incorporated friction tester model 98-25, model 32-06, or an equivalent. Testing can be done using either the inclined plane (slip angle) or horizontal test sled method. For horizontal testing, test sled C, having a size of approximately 2.5 inches by 2.5 inches and a weight of approximately 3 lbs., is used. For horizontal testing, the testing travel length is set at 2 inches and a sled travel speed of 6 inches per minute is used. Specimens are tested under standard TAPPI environmental test conditions allowing for sufficient time to condition the samples. Each test specimen requires two samples removed from the exterior surface 34 of the carton 14. The first sample is cut to fit the size of the test sled allowing for sufficient material to clamp or attach the sample to the test sled. The second sample is cut at least one inch wider than the test sled and sufficiently long for the test sled to travel at least 2 inches. The second sample is attached to the support table of the friction tester. The samples are positioned in the friction tester such that the exterior surface of the test sled sample contacts the exterior surface of the sample clamped to the support table of the friction tester (printed surface to printed surface). A minimum of five specimens are tested and averaged to determine the static coefficient of friction for the particular specimen being tested.

In one embodiment, as shown in FIG. 1, after sealing the second end of the tubular shape 21, the carton 14 is advanced through an oven 38 to raise the temperature of the carton's exterior surface 34 to activate the coating material 36, significantly increasing its thickness and creating a textured surface. Since the coating material 36 is activated after many of the carton handling operations have already been completed, the activated coating is less likely to become damaged during handling of the carton 14 by the carton filling line 10. Similarly, activating the coating material 36 after removing the carton sleeve from the feed magazine reduces or eliminates the chances of the coating material interfering with the process of removing a carton sleeve 20 from the feed magazine 22. After heat activating the coating material 36, the carton 14 can be conveyed to a case packer where multiple cartons are stacked into an array for insertion into a shipping box. Thereafter, the shipping boxes or cases are stacked on pallets for distribution to retailers.

Heating of the exterior surface 34 can be carried out by any number of processes including convention, conduction, or infrared radiation. In general, the coating material 36 should be raised to a temperature sufficiently high to gasify the foaming or blowing agent in the coating material causing it to expand. For example, the coating material can be heated to a temperature of at least about 150 degrees Fahrenheit (65 degrees C.) to activate, bloom, or expand the coating material. In other embodiments, the coating material 36 is raised to a temperature between about 150 degrees Fahrenheit (65 degrees C.) to about 350 degrees Fahrenheit (175 degrees C.). Activating the coating material 36 causes it to expand significantly increasing its thickness and also providing the textured surface. As shown in FIG. 3B, the coating material 36 becomes much thicker raising the top surface 40 of the coating material 36 significantly above the exterior surface 34 of the carton 14.

After being heat activated, the coating material 36 can expand up to about 40 times its original size. The heat activated coating can increase in thickness by a factor of about 2, 3, 4, 5, or more times the original thickness of the un-activated coating. The heat activated coating material can have a thickness of between about 0.005 inch to about 0.3 inch. The heat activated coating material can have a static coefficient of friction between about 0.30 to about 1.00. The heat activated coating material 36 on the exterior surface 34 can have an increased static coefficient of friction as compared to the un-activated coating material.

In alternative embodiments, instead of heat activating the coating material 36 after placing the tissue stack 18 into the carton 14, the coating material 36 can be heat activated after removing the carton sleeve 20 from the feed magazine 22. In some embodiments, it is desirable to delay heat activating the coating material 36 as long as possible in order to protect the surface texture of the activated coating from damage and to make it easier to handle the carton. In other embodiments, it is desirable to heat activate the coating material 36 shortly after removing the carton sleeve 20 from the feed magazine 22, thereby increasing the static coefficient of friction of the carton and enabling the machinery to better grip and transport the carton through the remainder of the carton filling line 10. In various embodiments, the coating material can be heat activated at any point in the filling or distribution process after removing the carton sleeve 20 from the feed magazine 22. For example, the coating material can be heat activated between the orbital erecting module 24 and the first sealing module 28. The coating material could be heat activated by either of the sealing modules (28, 32) or between the sealing modules. The coating material could be heat activated while residing in the stacked array of multiple cartons prior to inserting the array into the shipping box with a case packer. The coating material could be heat activated while carton 14 resides in the shipping box.

Additionally, to create a novelty item especially appealing to children, the coating material 36 could be heat activated by the end user of the carton to make the exterior surface 34 grow, morph, or change as a result of applying heat, thereby changing the appearance of the exterior surface. For example, the carton 14 or an instruction sheet could include written instructions, graphical symbols, or illustrations instructing the consumer to heat the exterior surface 34 with a conventional hair dryer, thereby heat activating the coating material 36 to change the texture of the exterior surface.

Coating materials 36 that can be heat activated to grow in thickness, to expand, to change their surface texture, or to change their coefficient of friction are aqueous based coatings sold by Polytex Environmental Inks under the trade names of AquaPuff, AquaRuff, Soft-Touch, or Velvet-Touch. Polytex Environmental Inks has an office located at 820 East 140th Street, Bronx, N.Y. 10454 and a website at http://www.polytexink.com. The coating materials are environmentally safe and aqueous based. Polytex Environmental Inks maintains the specific ingredients and formulations of their various expandable foam printing inks as a trade secret as noted in the Material Safety Data Sheets for the coating materials.

Another company supplying expandable foam printing inks for use as the coating material 36 is Triangle Ink, having an office located at 53-57 Van Dyke Street, Wallington, N.J. 07057 and a website at http://www.triangleink.com. Triangle Ink manufactures Tri-Puff Series—Foam Expanding Plastisol Inks, including Tri-Puff 1300 and Tri-Suede Puff 1600.

Another method of making the coating material 36 is to include microspherical plastic particles in a typical coating material applied to the cartons 14, such as a printing ink. The microsphere particles can be made from a polymer shell that encapsulates a gas. When the microsphere particle is heated, the thermoplastic shell softens, resulting in a large increase in volume of the microsphere particle that is retained once the microsphere particle cools and the thermoplastic shell hardens. One company making expanding microspherical plastic particles is Expancel Incorporated, having an office located at 2240 Northmont Parkway, Duluth, Ga. 30096 and a web site at http://expancel.com. The microspherical particle can have an unexpanded diameter between about 6 μm to about 40 μm. The microspherical particles can expand in volume up to about 40 times the original volume and have an activated diameter between about 20 μm to about 150 μm. A microspherical particle can be constructed from a copolymer shell of monomers such as vinylidene chloride, acrylonitrile and methymethacrylate that surrounds a blowing agent such as isobutene or isopentane. The microspherical particles can be heated to a temperature between about 100 degrees C. to about 200 degrees C. to cause the microspheres to expand.

Other foam expandable coatings can be used as disclosed in the following patents: U.S. Pat. No. 3,629,380 entitled Foam Surface Patterns; U.S. Pat. No. 4,055,613 entitled Production Of Three-Dimensional Designs; U.S. Pat. No. 4,083,907 entitled Process For Chemically Embossing Heat-Foamable Resinous Material Using Ag[q]ueous Alcoholic, Growth-Controlling Printing Ink Compositions; U.S. Pat. No. 4,094,685 entitled Expandable Polymeric Coating Compositions; U.S. Pat. No. 4,421,561 entitled Water Based Ink Compositions Using Organic Acid; and in U.S. published patent application 2004/0101675 entitled Use Of Collapsible Microspheres To Create Texture In Surface Coverings.

As discussed in U.S. Pat. No. 4,055,613, the foamable ink or coating can be applied from a water emulsion or an organic solvent. The inks and coatings contain the conventional dyes and/or pigments dispersed in aqueous or organic solvent systems (toluene, xylene, naphtha, etc.), and, in addition, contain expandable resin compositions. The latter include prepolymer and polymer compositions such as polystyrene, polypropylene, polyether-polyurethanes, polyester-polyurethanes, polyvinyl chloride acetate, polyvinyl acetate butyrate, melamine-flormaldehyde and urea-formaldehyde with blowing agents suspended therein. The blowing agents include volatile liquids such as low-boiling hydrocarbons and fluorocarbons and gas-liberating agents such as p,p′-oxybis(benzenesulfonylhydrazide), dinitrosopentamethyl-enetetramine, azobisformamide, benzenediazonium sulfate, 1,1′-diazoaminonaphthalene, and related organic azides, hydrazides and diazo compounds which release nitrogen on heating. Expandable resin compositions suitable for use are also disclosed in “Rigid Plastic Foams” by T. H. Ferrigno, second edition, Reinhold Publishing Corporation, 1967. The inks and coatings can be applied by printing or rolling to produce the desired design. After the ink or coating has dried on the sheet, web or exterior surface 34, it is expanded by heating from about 100 degrees to about 225 degrees C. The heat causes the blowing or foaming agent to give off gas (e.g., nitrogen, carbon dioxide, hydrocarbon gas, etc.), which causes the layer of ink or coating to expand to 5 to 15 times its original volume, thus producing a three-dimensional pattern. By controlling the thickness of the layer of ink or coating, and varying the rate of application in certain areas, it is possible to produce patterns in this way which vary in thickness from one area to another by as much as fivefold. Direct transfer coating of the ink to the sheet is preferred, and screen printing and gravure applications are recommended. Other coating methods include curtain coating, knife and knife-over-roll coating, reverse roll, curtain coater and flexo. Heating is accomplished with forced hot air or infrared illumination.

The coating materials 36 can be applied to the carton's interior or exterior surface by conventional printing methods such as gravure, screen, or flexographic printing techniques. Thus, any number of intricate graphical designs, shapes, indicia, and colors can be applied to the carton's surfaces. The heat activated coating material can be applied to the entire exterior surface 34 of the carton 14 or to selected portions to enhance the textured feel of the carton. For example, in FIGS. 2 and 3B, the coating material 36 is applied to create the flower patterns, creating a significant difference in height between top surfaces 40 of the flower elements and the uncoated areas of the exterior surface 34.

Functional features of the carton 14 can be made using the heat activated coating materials 36. The heat activated coating material can be applied to the exterior surface 34 in specific locations with conventional inks and varnishes applied in other locations to produce textured and non-textured areas of the exterior surface. For example, it may be desirable to have the carton's top and sidewall printed with Velvet-Touch to provide a soft flocked feel to the carton's surface that the consumer would ordinarily touch when handling the carton. It also may be desirable, either in combination with the Velvet-Touch or separately, to apply AquaRuff to the carton's bottom surface to increase the coefficient of friction helping to prevent the carton from sliding around on surfaces. For cartons likely to be exposed to wet or damp surfaces, it may be desirable to apply AquaPuff to the bottom four corners of the carton to create buttons, posts, or legs that elevate the majority of the carton's bottom from the damp surface, thereby helping to protect the product, such as facial tissue, inside of the carton from becoming wet. AquaRuff can be applied to strategic areas of the carton to provide gripping surfaces either for the consumer to hold and manipulate the carton or to better enable the conveying and carton filling line to move the carton with less slippage during the filling and case packing operations.

Structural features of the carton can be improved by the use of the heat activated coating materials. For example, AquaRuff can be applied to pull tabs, removable panels, or other features of the carton intended to be utilized to open the carton, making it easier to grip these features due to the increased coefficient of friction. AquaPuff can be applied to the bottom surfaces of pull tabs or removable panels such that upon heat activation, a portion of the surface is popped-up or extends from the surrounding surfaces making it easier to locate and use the opening function. AquaPuff can be utilized as a gasket material to help fill in cracks and crevasses between mating surfaces of the carton.

In one embodiment, the entire exterior surface 34 of the carton can be heat activated at substantially the same time by passing the carton 14 through an oven 38, as illustrated in FIG. 1. In other embodiments, a selected portion of the exterior surface 34 of the carton can be heat activated at one point in time in the process, and another selected portion of the exterior surface of the carton can be heat activated at a different point in time later in the process. For example, it may be desirable to have a portion of the exterior surface 34 utilized as a gripping surface by the carton filling line 10. Those areas of the carton 14 used as a gripping surface can be heat activated by selectively heating only those areas of the carton at a point in time early in the carton filling process. The exterior surface 34 of the carton 14 may also contain other areas which provide primarily an aesthetic look or texture that might be damaged by the carton filling line 10. Such features could be heat activated later in time in the process or by a consumer, thereby better protecting the surface from damage.

Other modifications and variations to the present invention may be practiced by those of ordinary skill in the art, without departing from the spirit and scope of the present invention, which is more particularly set forth in the appended claims. It is understood that aspects of the various embodiments may be interchanged in whole or part. All cited references, patents, or patent applications in the above application for letters patent are herein incorporated by reference in a consistent manner. In the event of inconsistencies or contradictions between the incorporated references and this application, the information present in this application shall prevail. The preceding description, given by way of example in order to enable one of ordinary skill in the art to practice the claimed invention, is not to be construed as limiting the scope of the invention, which is defined by the claims and all equivalents thereto.

I claim:

1. A method of making a textured carton surface comprising the steps of
applying a coating material to at least a portion of the exterior surface of a carton blank or a carton sleeve;
placing the carton sleeve into a feed magazine of a carton filling line;
removing the carton sleeve from the feed magazine; and thereafter
heating at least a portion of the exterior surface activating the coating material forming the textured carton surface.

2. The method of claim 1 comprising erecting the carton sleeve into a tubular shape by an orbital erecting module and then heating the exterior surface to activate the coating material.

3. The method of claim 2 comprising inserting a stack of facial tissue into the tubular shape, closing and sealing a plurality of sealing flaps on the tubular shape forming a carton, and then heating the exterior surface to activate the coating material while the carton resides on a carton conveyor.

4. The method of claim 1 comprising instructing a consumer to heat the exterior surface, activating the coating material forming the textured surface.

5. The method of claim 2 comprising inserting a stack of facial tissue into the tubular shape, closing and sealing a plurality of sealing flaps on the tubular shape forming a carton, and instructing a consumer to heat the exterior surface activating the coating material forming the textured surface.

6. The method of claim 1 wherein the coating material comprises an expandable foam printing ink.

7. The method of claim 1 wherein the coating material comprises a thickness between about 0.001 inch to about 0.100 inch prior to being heated.

8. The method of claim 7 wherein the coating material increases in thickness by a factor of about 2 or more after being heated.

9. The method of claim 7 wherein the coating material has a thickness between about 0.005 inch to about 0.3 inch after being heated.

10. The method of claim 1 comprising heating the exterior surface to a temperature between about 150 degrees to about 350 degrees Fahrenheit.

11. The method of claim 1 wherein the exterior surface prior to being heated comprises a static coefficient of friction between about 0.05 to about 0.35.

12. The method of claim 1 wherein the exterior surface prior to being heated comprises a static coefficient of friction between about 0.05 to about 0.25.

13. The method of claim 1 wherein the exterior surface comprises a static coefficient of friction prior to being heated and the static coefficient of friction of the exterior surface is increased after the exterior surface is heat activated.

14. The method of claim 1 wherein the exterior surface after being heat activated comprises a static coefficient of friction and the static coefficient of friction is between about 0.30 to about 1.0.

15. The method of claim 1 comprising heating the entire exterior surface at substantially the same time.

16. The method of claim 1 comprising heating a selected portion of the exterior surface at one point in time and then heating another selected portion of the exterior surface at a different point in time.

17. A method of making a textured carton surface comprising the steps of
applying a coating material to at least a portion of the exterior surface of a carton blank or a carton sleeve;
filling the carton with a consumer product; and
heating at least a portion of the exterior surface activating the coating material forming the textured carton surface.

18. The method of claim 17 wherein the coating material comprises an expandable foam printing ink.

19. The method of claim 17 wherein the consumer product comprises tissue paper.

20. The method of claim 17 wherein the exterior surface prior to being heated comprises a static coefficient of friction between about 0.05 to about 0.35.
